(19) United States
(12) Patent Application Publication
(10) Pub. No.: US 2018/0047050 A1
(43) Pub. Date: Feb. 15, 2018

(54) METHOD OF AUTOMATED COMPUTER SCREENING OF CLICKS WITH PAY-PER-CLICK ADVERTISING

(71) Applicant: Christopher Darrin WONG, Victoria (CA)

(72) Inventor: Christopher Darrin WONG, Victoria (CA)

(21) Appl. No.: 15/672,595

(22) Filed: Aug. 9, 2017

(30) Foreign Application Priority Data
Aug. 15, 2016 (CA) 2939351

(51) Int. Cl. G06Q 30/02

(52) U.S. Cl. CPC G06Q 30/0248; G06Q 30/0249; G06Q 30/0246

(57) ABSTRACT

A method of automated computer screening of clicks with pay-per-click advertising involves providing an advertiser portal which allows an advertiser to post a video advertisement and establish a database of questions relating to the content of the video advertisement. The computer is programmed with a set of instructions causing the computer to display to the viewer who has initiated a pay-per-click link a random subset of questions along with a choice of possible answers. The computer to reward credits to the viewer only if an answer selected by the viewer from the possible answers is the correct answer.

### FIELD

There is described a method for computer screening of clicks with pay-per-click advertising, the method being automated with a view to eliminating payments being made for clicks that are not “legitimate”.

### BACKGROUND

Click fraud is commonly associated with pay-per-click (PPC) advertising. Click fraud is an illegal practice that occurs when individuals click on a website's click through Advertisements (either banner ads or paid text links and recently video) to increase the payable number of clicks to the advertiser. The illegal clicks are either performed by a person manually click the advertising hyperlinks or by automated software or online bots that are programmed to click these banner ads and pay per click text ad links. Research has indicated that click fraud is perpetrated by individuals who use click fraud to increase their own personal banner ad revenues and also by companies who use click fraud as a way to deplete a competitor's advertising budget.

Invalid clicks are accidental clicks and other mechanically generated clicks that, while not fraudulent, are not the result of genuine user clicks. Invalid clicks can also be costly for advertisers.

A problem currently experienced with pay-per-click advertising systems, is that a computer is presently unable to determine which clicks are “legitimate” clicks.

### SUMMARY

There is provided a method of automated computer screening of clicks with pay-per-click advertising. This method involves providing an advertiser portal which allows an advertiser to post a video advertisement and establish a database of questions relating to the content of the video advertisement along with a choice of possible answers and an indication as to a correct answer to each question in the database of questions. This method involves providing a public interface through which a viewer can view the video advertisement posted by the advertiser. This method involves providing a pay-per-click link at the termination of the video advertisement to facilitate receipt of rewards to a viewer for having viewed the video advertisement. This method involves providing a random question generator capable of generating a random subset of questions from the database of questions provided by the advertiser. This method involves programming the computer with a set of instructions causing the computer to display to the viewer who has initiated the pay-per-click link the random subset of questions generated by the random question generator along with the choice of possible answers. This method involves programming the computer to reward credits to the viewer only if an answer selected by the viewer from the possible answers with respect to the random subset of questions is the correct answer.

The viewer is paid for each correct answer so, depending upon their score, they receive anywhere from 0% to 100% of the payout allotment. The system is intended to prevent click fraud by ensuring that viewers watch the video to completion and demonstrate a reasonable comprehension of what they have viewed by answering questions which pertain directly to the video they have just viewed. The random question generator prevents the use of programmable computer bots being used to commit click fraud.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a screen shot of a webpage providing an advertiser portal.

FIG. 2 is a screen shot of a webpage providing an advertiser with a mechanism to upload a video advertisement and fund a viewer rewards program.

FIG. 3 is a screen shot of a webpage providing an advertiser with a mechanism to upload questions with multiple choice questions regarding the video advertisement.

FIG. 4 is a screen shot of a webpage displaying a first question established by the advertiser.

FIG. 5 is a screen shot of a webpage displaying a second question established by the advertiser.

FIG. 6 is a screen shot of a webpage displaying a third question established by the advertiser.

FIG. 7 is a screen shot of a webpage displaying the video advertisement.

FIG. 8 is a screen shot of a webpage displaying a viewer rewards notification.

FIG. 9 is a screen shot of a webpage displaying a first of random subset of questions to be answered by the viewer.

FIG. 10 is a screen shot of a webpage displaying the results to the viewer.

FIG. 11 is a screen shot of a webpage showing a credit awarded to the viewer for having viewed the video advertisement and correctly answered the questions.

FIG. 12 is a Flow Chart setting forth instructions to the computer

### DETAILED DESCRIPTION

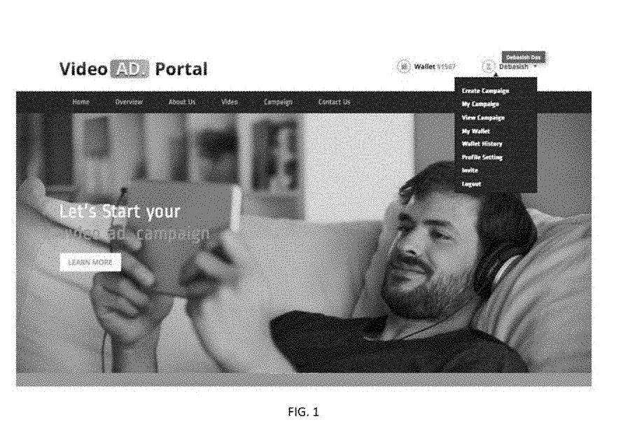

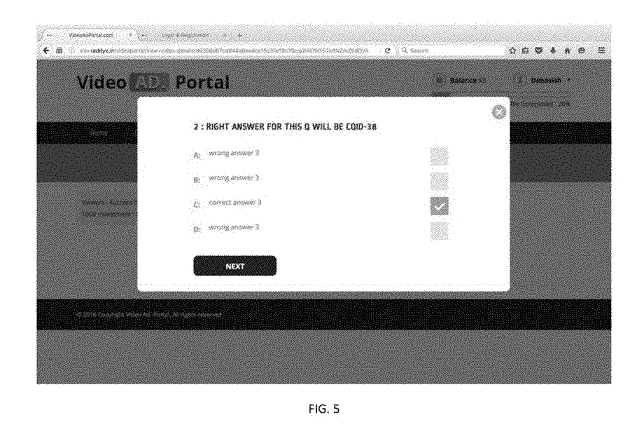

A method of automated computer screening of clicks with pay-per-click advertising generally identified by reference numeral 10, will now be described with reference to FIG. 1 through FIG. 12.

### Method:

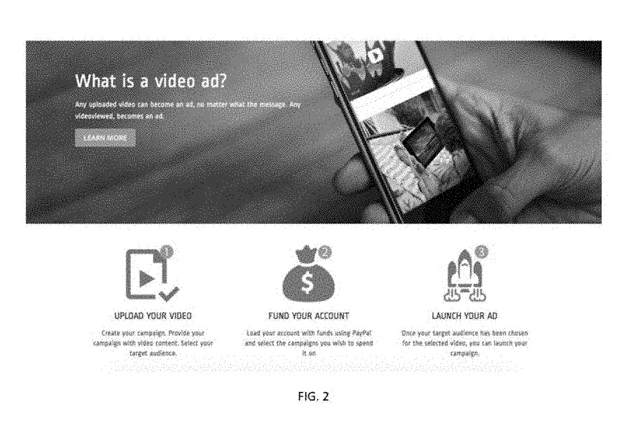

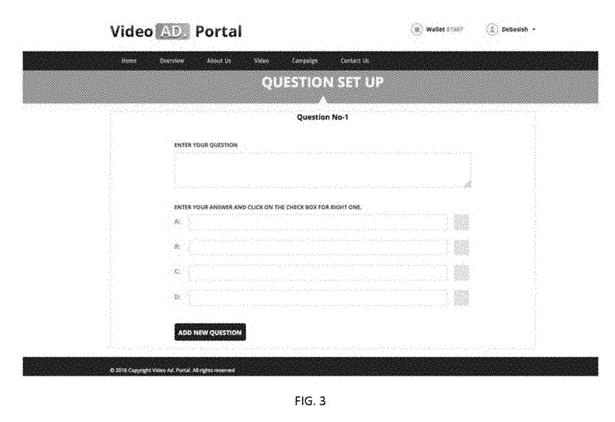

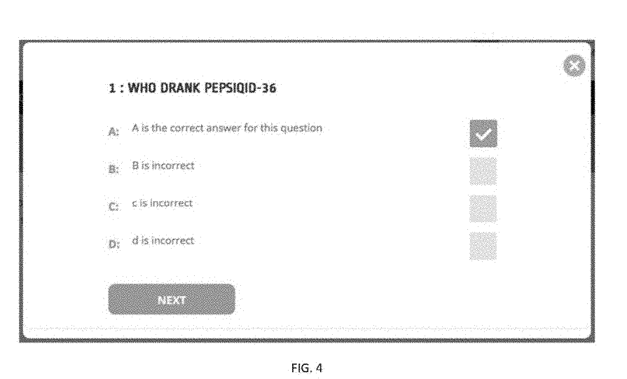

Referring to FIG. 1, there is provided an advertiser portal. Referring to FIG. 2, there is provided a mechanism which an advertiser to post a video advertisement and fund a viewer rewards account. Referring to FIG. 3 there is provided a mechanism to establish a database of questions relating to the content of the video advertisement along with a choice of possible answers and an indication as to a correct answer to each question in the database of questions. Referring to FIG. 4 through 6, a series of illustrative sample questions are shown.

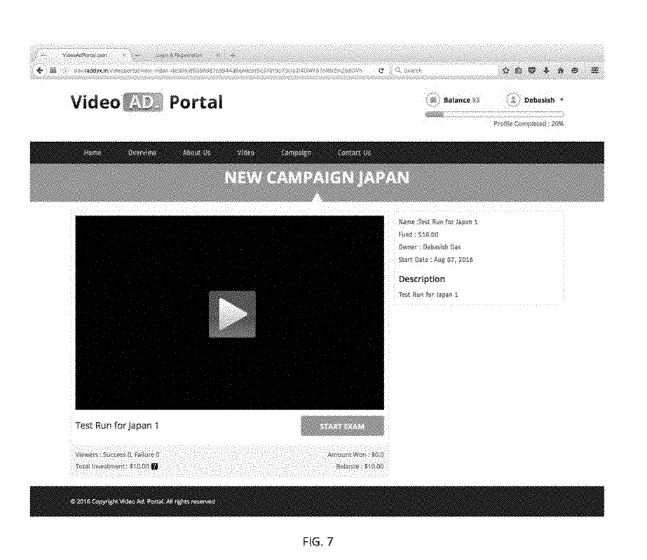

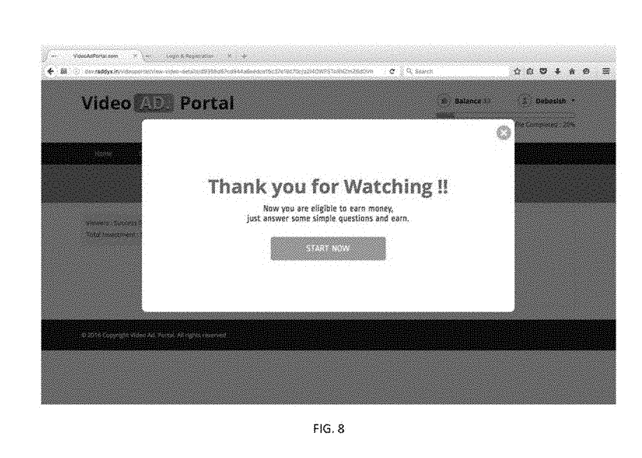

Referring to FIG. 7, there is provided a public interface through which a viewer can view the video advertisement posted by the advertiser. Referring to FIG. 8, there is provided a pay-per-click link at the termination of the video advertisement to facilitate receipt of rewards to a viewer for having viewed the video advertisement.

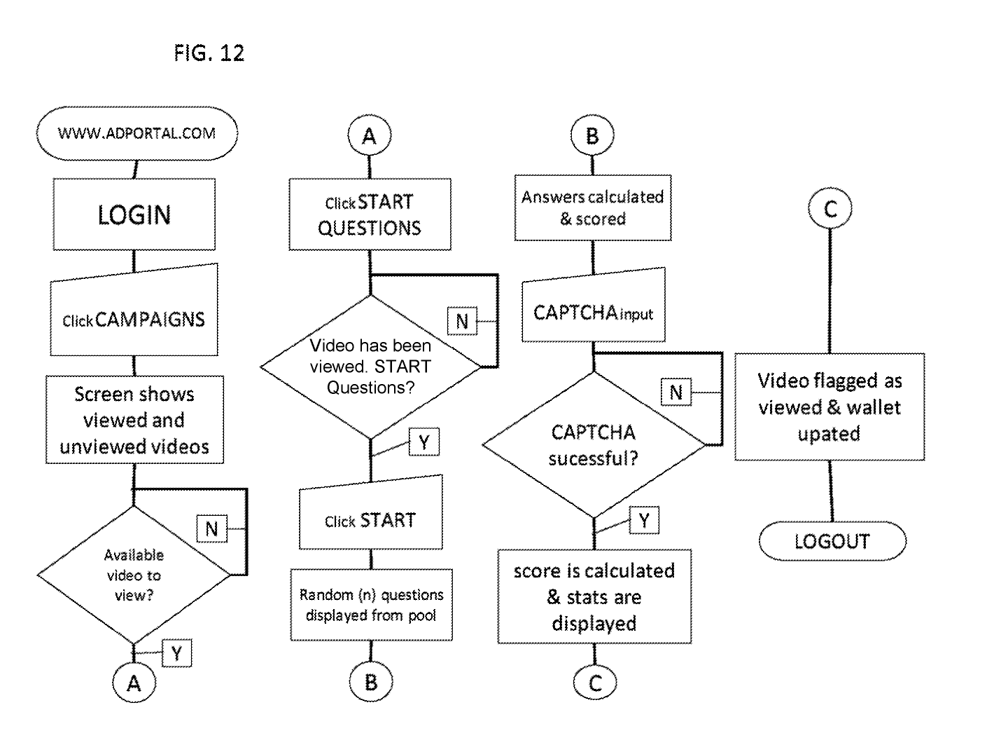

Referring to FIG. 12, there is provided a Flow Chart setting forth a set of instructions to the computer from Login to Logout. It is to be noted that the computer is programmed with a set of instructions causing the computer to display to the viewer who has initiated the pay-per-click link the random subset of questions generated by the random question generator along with the choice of possible answers.

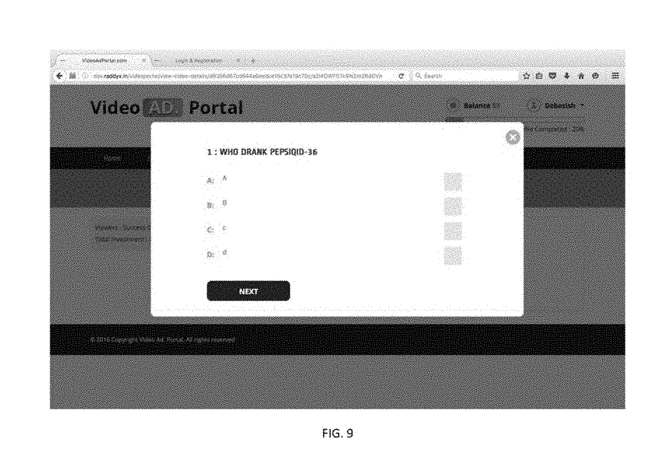

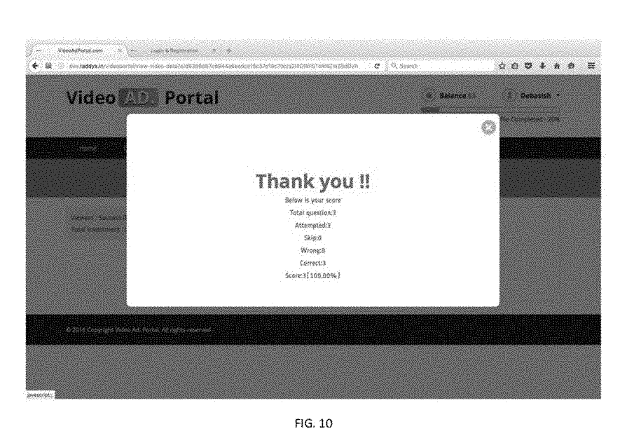

Referring to FIG. 9, there is illustrated a first of a series of the random subset of questions that the viewer must answer. Referring to FIG. 10, there is shown that the viewer attempted to answer three questions and answered each question correctly.

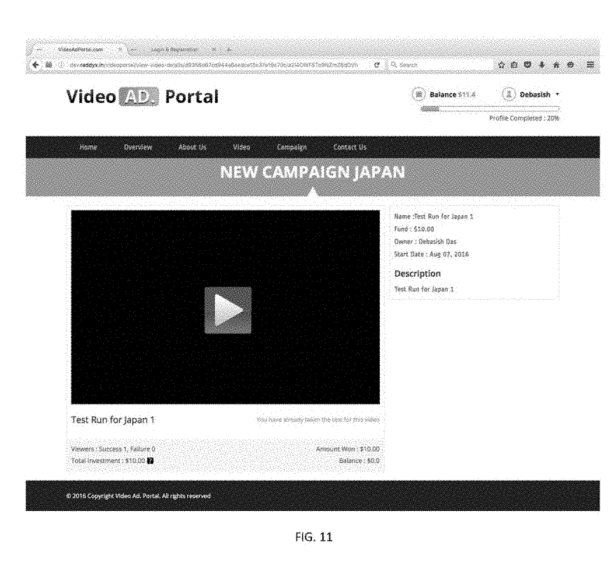

Referring to FIG. 12, the set of instructions instructs the computer to reward credits to the viewer only if an answer selected by the viewer from the possible answers with respect to the random subset of questions is the correct answer. Referring to FIG. 11, as the viewer has correctly answered the three questions posed, the viewer has qualified for reward credits. The computer has credited the viewer with the reward credits as can be seen from the credit balance bar in the upper right hand corner of the webpage. The viewer is paid for each correct answer so, depending upon their score, they receive anywhere from 0% to 100% of the payout allotment. The system is intended to prevent click fraud by ensuring that viewers watch the video to completion and demonstrate a reasonable comprehension of what they have viewed by answering questions which pertain directly to the video they have just viewed. The random question generator prevents the use of programmable computer bots being used to commit click fraud.

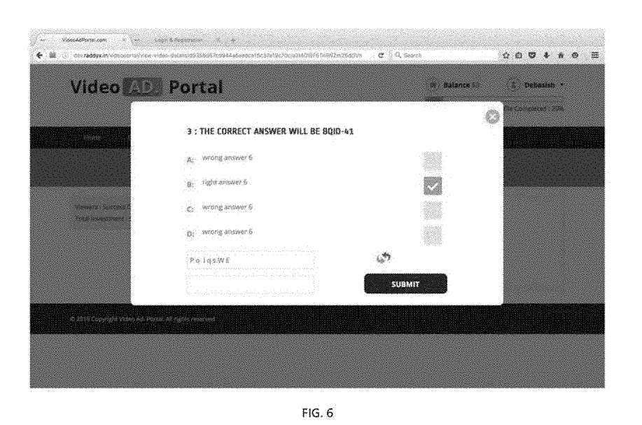

Referring to FIG. 6 and FIG. 12, as additional protection, a captcha mechanism is in place on the last question of the random subset of question to prevent a bot from completing the question set.

### In Summary:

Click fraud is perpetrated for financial gain or to deplete a competitor budget. This Anti click fraud mechanism has been designed to prevent click fraud from both bots and human users. Questions are always randomly chosen from a pool, resulting in a different set of questions presented each time the test is taken by a viewer. Therefore, there can be no reusable answer key. A human viewer cannot carelessly jump through the questions and answer indiscriminately, as doing so would result in a lower percentage of the payout allotment. The random nature of the questions helps prevent click fraud being committed on a mass scale through the use of programmable computer bots. As additional protection, a captcha mechanism can be placed on the last question of the series to prevent a programmable computer bot from completing the question set.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A method of automated computer screening of clicks with pay-per-click advertising, comprising:
providing an advertiser portal allowing an advertiser to post a video advertisement and establish a database of questions relating to the content of the video advertisement along with a choice of possible answers and an indication as to a correct answer to each question in the database of questions;
providing a public interface through which a viewer can view the video advertisement posted by the advertiser;
providing a pay-per-click link at the termination of the video advertisement to facilitate receipt of rewards to a viewer for having viewed the video advertisement;
providing a random question generator capable of generating a random subset of questions from the database of questions provided by the advertiser;
programming the computer with a set of instructions causing the computer to display to the viewer who has initiated the pay-per-click link the random subset of questions generated by the random question generator along with the choice of possible answers; and
programming the computer to reward credits to the viewer only if an answer selected by the viewer from the possible answers with respect to each of the random subset of questions is the correct answer.

2. The method of claim 1, wherein a captcha mechanism is provided at the conclusion of the last question of the random subset of questions.
